(19) United States
(12) Patent Application Publication
(10) Pub. No.: US 2016/0314476 A1
(43) Pub. Date: Oct. 27, 2016

(54) SYSTEM AND METHOD FOR VALIDATING THE AUTHENTICITY OF A REVIEW OF A BUSINESS OR SERVICE PROVIDER

(71) Applicant: SHT LST LLC, AUSTIN, TX (US)

(72) Inventor: ROSS CLURMAN, AUSTIN, TX (US)

(73) Assignee: SHT LST LLC, AUSTIN, TX (US)

(21) Appl. No.: 15/134,033

(22) Filed: Apr. 20, 2016

Related U.S. Application Data
(60) Provisional application No. 62/150,576, filed on Apr. 21, 2015.

(51) Int. Cl. G06Q 30/00; G06Q 30/02

(52) U.S. Cl. CPC G06Q 30/0185; G06Q 30/0282

(57) ABSTRACT

A business service provider review validation system broadly comprising a remote server, a plurality of business service provider hardware devices, and one or more computer programs or applications for validating and managing reviews. The remote server hosts a business service provider review website or mobile application and maintains business service provider reviews uploaded thereto. The business service provider hardware devices each present business service provider review identifiers to reviewers when the reviewers patronize a business service provider. Each business service provider review identifier may be a unique code corresponding to a single review or set of reviews related to a reviewer or a set of reviewers' experience or experiences in patronizing the business service provider. The business service provider review identifiers each include a business service provider identifier corresponding to one of the business service providers.

### RELATED APPLICATIONS

This application is a non-provisional regular utility application, and claims priority benefit with regard to all common subject matter, of earlier-filed U.S. Provisional Patent Application Ser. No. 62/150,576, filed on Apr. 21, 2015, and entitled “SYSTEM AND METHOD FOR VALIDATING THE AUTHENTICITY OF A REVIEW OF A BUSINESS OR SERVICE PROVIDER.” The identified earlier filed provisional patent application is hereby incorporated by reference in its entirety into the present application.

### BACKGROUND

Patrons of restaurants, car washes, movie theaters, and other business service providers often use review systems to express satisfaction or dissatisfaction with their recent experiences. Potential patrons may then read submitted reviews to determine which business service providers they would like to patronize. Business service providers are thus incentivized to improve their services and/or business practices. However, many review systems do not verify that submitted reviews are generated by actual patrons of the business service providers. That is, some reviews are generated by computer programs or by non-patrons such as disgruntled employees or competitors. Other reviews are duplicates, which skews review statistics. Many reviews are un-insightful, disingenuous, or otherwise low quality. All of these factors lower the overall reliability and accuracy of the reviews, which reduces trustworthiness and effectiveness of business service provider review systems.

### SUMMARY

Embodiments of the present invention solve the above-mentioned problems and provide a distinct advance in business service provider review systems. More particularly, the present invention provides a system and method for validating business service provider reviews in which reviews are assigned unique identifiers and associated with a business service provider to reduce the number of counterfeit, duplicate, and/or machine-generated reviews.

An embodiment of the present invention is a review validation system broadly comprising a remote server, a plurality of business service provider hardware devices, and one or more computer programs or applications for validating and managing reviews. The remote server hosts a business service provider review website or mobile application and maintains business service provider reviews uploaded thereto. The business service provider hardware devices each present business service provider review identifiers to reviewers when the reviewers patronize a business service provider. Each business service provider review identifier may be a unique code corresponding to a single review or set of reviews related to a reviewer or a set of reviewers' experience or experiences in patronizing the business service provider. The business service provider review identifiers each include a business service provider identifier corresponding to one of the business service providers. The computer programs allow reviewers to create reviews via graphical user interfaces of their mobile devices. The computer programs then validate the reviews via unique business service provider review identifiers. In this way, reviews are more easily authenticated, thus improving potential patrons' confidence in review legitimacy and accuracy.

Another embodiment of the present invention is a computer-implemented method of validating a review of a business service provider. The method includes hosting a business service provider review website on a remote server. A business service provider review identifier may be presented to a reviewer when the reviewer patronizes a business service provider. The business service provider review identifier may be a unique code corresponding to a review or set of reviews related to the reviewer or a set of reviewers' experience or experiences in patronizing the business service provider. The business service provider review identifier may include a business service provider identifier corresponding to one of the business service providers. The reviewer may then be prompted to enter a review into his mobile device. The review may then be validated by linking the business service provider review identifier to the review and checking previously uploaded reviews stored on the remote server to verify that the previously uploaded reviews are not linked to the business service provider review identifier. The validated review may then be stored on the remote server such that potential patrons of the business service provider can view the review via their mobile devices.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic diagram of a business service provider review validation system constructed in accordance with an embodiment of the present invention;

FIG. 2 shows a business service provider review identifier in quick response code (QRC) form;

FIG. 3 shows a business service provider review identifier in universal product code (UPC) form;

FIG. 4 is a flow diagram of steps for setting up a business service provider review validation system in accordance with a method of the invention; and

FIG. 5 is a flow diagram of steps in a method of validating a business service provider review.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to one embodiment“, an embodiment”, or “embodiments” mean that the feature or features being referred to are included in at least one embodiment of the technology. Separate references to one embodiment“, an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

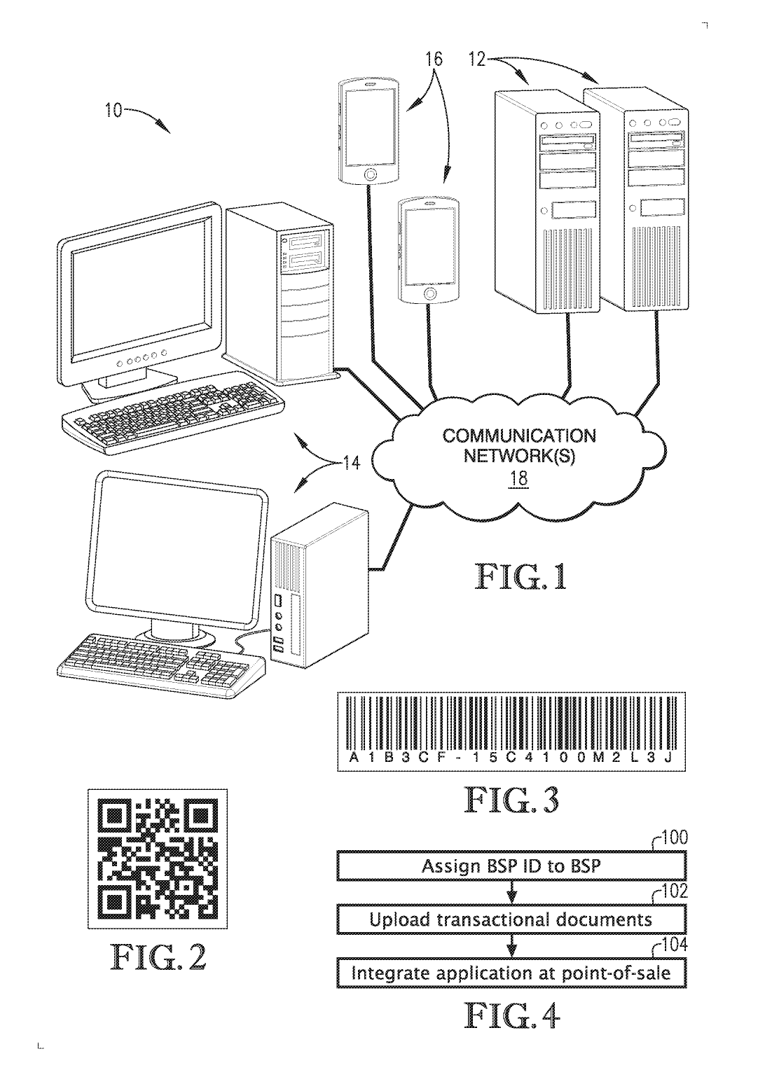

With reference to the drawing figures, and particularly FIG. 1, a system 10 and method for validating a business review is illustrated. The validation system 10 broadly comprises a plurality of remote servers 12, a plurality of business service provider hardware devices 14, a plurality of reviewer mobile devices 16, and one or more computer programs or applications for validating and managing reviews.

The remote servers 12 store and validate reviews submitted by reviewers via their mobile devices 16 and are operated by a validation service provider. The remote servers 12 include memory elements for storing large amounts of data, processors for analyzing and validating the data, and transceivers for communicating with the mobile devices 16 and other servers over a wireless communication network 18. The remote servers 12 may host a website or registration portal for businesses and/or service providers (BSPs) and reviewers (e.g. consumers and patrons) to log into and manage their accounts with the provider.

Embodiments of the remote servers 12 may include one or more servers running Windows; LAMP (Linux, Apache HTTP server, MySQL, and PHP/Perl/Python); Java; AJAX; NT; Novel Netware; Unix; Mac OS; or any other software system. As mentioned above, the remote servers 12 include or have access to computer memory and other hardware and software for receiving, storing, accessing, and transmitting information via the wireless communication network 18. The remote servers 12 may also include conventional web hosting operating software, searching algorithms, and an Internet connection, and are assigned URLs and corresponding domain names so that they can be accessed via the Internet in a conventional manner.

The BSP hardware devices 14 create and/or broadcast a BSP review ID for a reviewer's mobile device 16 to use when validating a review and are owned or hosted by the BSPs. The BSP hardware devices 14 each may include one or more BSP chips, BSP USB keys, one-time-use or reusable BSP cards, receipt printers, or electronic receipt (e-receipt) programs and systems. The BSP USB key may be used to program the BSP Chip to emit a unique BSP Review ID via RFID, NFC signal, Wi-Fi signal, low-frequency (LF) signal, ultra-low frequency (ULF) signal, Bluetooth, or if the BSP uses several or a combination of these devices to create a geo-fence in/around/near their BSP. Each BSP review ID may be a sixteen-character alphanumeric code. The first six characters may be a BSP ID unique to the BSP and the remaining ten characters may be a single use review ID. The BSP cards may have BSP review IDs printed on them in a computer-readable format such as a QRC (quick-response code), UPC bar code, proprietary graphical or numeric code (e.g. Microsoft's QRC graphics), as shown in FIGS. 2 and 3. The receipt printers may print a BSP review ID in a similar computer-readable format onto a receipt, regular piece of paper (such as a business card), invoice, or other transactional document that mobile devices 16 may detect via their camera, RFID component, NFC component, Bluetooth chipset, Wi-Fi chipset, GPS chipset, or other signal detection hardware/software. Alternatively, the BSP hardware devices 14 may simply display or print an alpha-numeric BSP review ID for the reviewer to input manually into the graphical user interface of the validation application. The printed BSP review ID may be printed on a physical document, transactional document (such as an invoice or shipping label), or included with an electronic receipt or document (such as a PDF or image).

The mobile devices 16 run a validation application for creating, validating, and managing reviews and may be smartphones, tablets, laptop computers, PDAs, handheld game devices, or any other mobile devices. The mobile devices 16 each may include a processor, a memory, a display, a camera, and a transceiver. The processor runs the validation application and the memory stores the validation application, reviews, and other data therein. The display may be a touchscreen or similar display for presenting a graphical user interface of the validation application to the reviewer. The camera may be a high definition camera configured to capture images and video clips and scan computer-readable codes such as bar codes and quick response codes (QRC) printed on receipts and other documents. The transceiver allows the mobile device 16 to communicate with the remote servers 12 over the wireless network 18. The mobile devices 16 may be configured to communicate via Bluetooth, radio frequency, 3G, 4G, or 5G technology and may be configured to detect radio frequency identification (RFID) and/or near field communications (NFC). The graphical user interface includes virtual images, text, text input boxes, checkboxes, buttons, and other user-selectable inputs. The graphical user interface may include user instructions in the form of text, icons, images, videos, and other visual cues.

The executable computer code described herein is provided for implementing logical functions in the mobile devices 16 and the other computer devices and servers of the present invention and can be embodied in any non-transitory computer-readable medium for use by or in connection with an instruction execution system, apparatus, device, or other system that can fetch the instructions from the instruction execution system, apparatus, or device, and execute the instructions. In the context of this application, a “non-transitory computer-readable medium” can be any non-transitory memory that can contain, store, or communicate the programs. The non-transitory computer-readable medium can be, for example, but not limited to, an electronic, magnetic, optical, electro-magnetic, infrared, or semi-conductor system, apparatus, or device. More specific, although not inclusive, examples of the non-transitory computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The validation application or computer programs may be distributed between portable electronic devices or may be downloaded from a virtual application marketplace such as the App Store and Google Play. The validation application may be stored on the non-transitory memory of the mobile devices 16 or may reside on one of the server computers 12 and can be accessed over the wireless communication network 18.

The review validation system 10 may be set up as follows. First, the provider assigns a BSP ID to the BSP, as shown in block 100 of FIG. 4. A provider representative may assign the unique ID to the BSP or the unique ID may be assigned automatically, via the validating application 10 using an algorithm, numerical count system, or random code generation method. The representative may search for a BSP in the validation application and may assign a BSP ID to the BSP if it does not already have one. If the BSP already has a BSP ID, the representative may have the option to reassign the BSP ID. The representative may scan a QRC or may manually enter a personal identification number (PIN) linked to the BSP cards so that the validation application will link the representative and the newly assigned BSP ID to that BSP. The provider may assign a unique BSP ID to a BSP regardless of whether or not the BSP has registered with the provider. BSPs may register with a free or paid account and may request promotional materials such as BSP cards, brochures, banners, or other collateral for displaying at their retail location. The provider may then distribute BSP hardware 14 such as BSP cards (with embedded RFID or NFC chips), BSP chips (that may be attached to products, business cards, receipts, shopping bags, or other items), and/or BSP USB keys to paying BSPs. The provider may also distribute pre-printed or print-ready BSP cards, such as business-card-sized promotional materials.

BSPs with paid accounts may upload their receipt, invoice, transactional document, or shipping label artwork or otherwise provide their receipt (including a gift receipt, which is slightly different), invoice, transactional document, or shipping label designs to the provider and link their artwork individually to a BSP or to a group of BSPs, as shown in block 102. For example, the provider may link a BSP's various artwork and designs with a group of related franchise establishments, or chain of locations within the same group. The provider may also manually link receipt, invoice, transactional document, or shipping label artwork and/or designs to BSPs within the remote servers 12 to enable customers of a franchise of a large BSP chain to validate reviews before the franchise BSP registers for a paid account.

BSPs registered with the provider as a paid account may also opt to integrate the provider's software, such as the validation application, with their point-of-sale and/or order management software, as shown in block 104. The BSPs may automatically validate a BSP review ID by registering it with the provider, online or via an Internet-connected device on the provider's website or within the provider's mobile application. Paid account registered BSPs may then print their BSP review IDs, BSP review QRCs, and/or instructions on receipts, invoices, shipping notifications, and other costumer-facing transactional documents.

Alternatively, BSPs registered with the provider as a paid account may order a BSP USB key that can be plugged into a register at their retail locations. Each BSP USB key will emit a unique BSP review ID RFID, NFC, Wi-Fi, Bluetooth, or other signal that nearby mobile devices 16 can detect and use to authenticate a rating/review created by a person in close proximity to the BSP USB key.

As yet another option, BSPs registered with the provider as a paid account may integrate and embed programmable BSP chips into their point-of-sale kiosks, programmable pads near their credit card machines, or check presenter booklets. The BSP may use the USB key to program a BSP chip to emit a BSP review ID as described above.

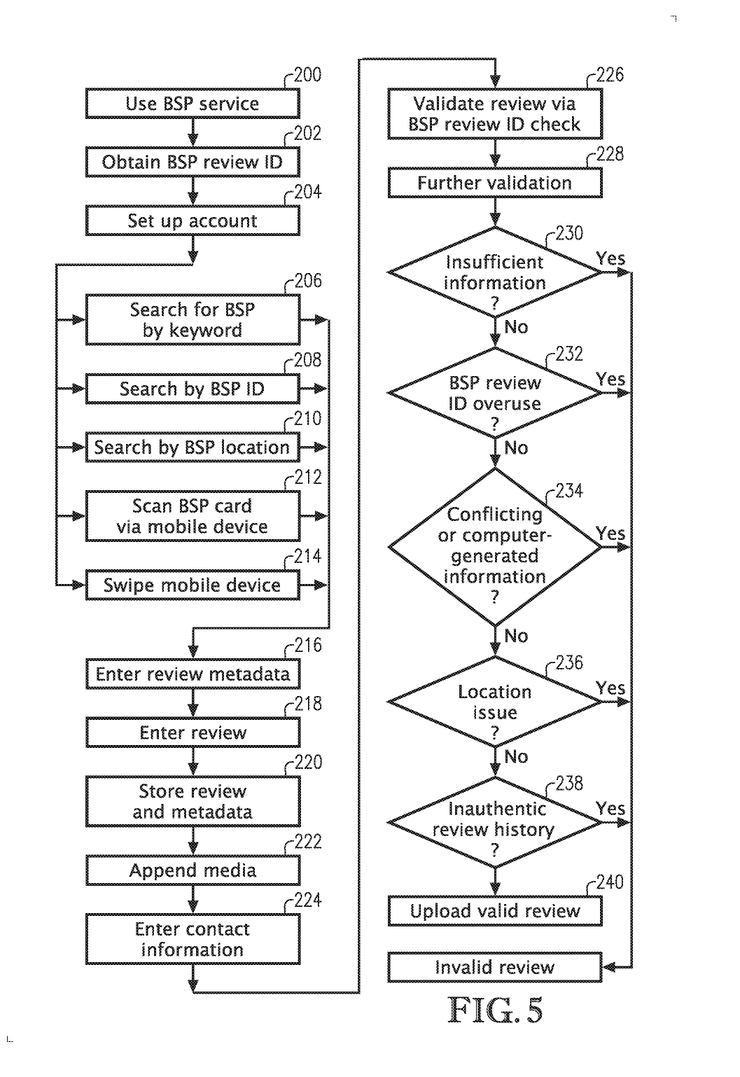

A reviewer may create a review for a BSP as follows. First, the reviewer may make a purchase or avail himself to the BSP's services, as shown in block 200 of FIG. 5. For example, the reviewer may eat dinner, watch a movie, or purchase merchandise or services (e.g. utilities) from the BSP.

The BSP or a BSP representative may provide the reviewer with a BSP review ID printed on a BSP card, a receipt, invoice, promotional material, or other transactional document during or when finalizing the transaction, as shown in block 202. The BSP representative may also instruct the reviewer how to create a review.

The reviewer may then install the validation application onto his or her smartphone or other mobile device, laptop, or desktop computer, if it is not already installed and may set up an account or register with the provider as a reviewer (consumer user), as shown in block 204. The reviewer may alternatively use the application as a guest or anonymous user.

The reviewer may then access the application via an on-premise kiosk, on-premise mobile device, their own mobile device, such as a smartphone or tablet, their laptop, or desktop computer, and start a new rating or review for a BSP by first identifying the BSP in one of the following ways. The reviewer may search for the BSP by entering the BSP's name or a keyword related to the BSP into the text input area of the graphical user interface of his mobile device 16 if a BSP representative did not provide the reviewer with a BSP ID or BSP review ID, as shown in block 206. For example, the reviewer may type “downtown sushi” into the text input area to bring up sushi restaurants located in a nearby downtown area based on the reviewer's location determined by Wi-Fi location, geo-fence location, GPS location, device IP address, or similar location-detection methods. The validation application may filter matching BSP results from an auto-populated list of nearby BSPs, sorted by those closest to the reviewer's current location and closest match to the entered text, such as a keyword related to the BSP, or the BSP's actual name. The reviewer may then select a BSP from the list and provide a BSP review ID, detect the BSP review ID via a wireless signal as described above, or enable location-detection for validating the review.

The reviewer may alternatively search for the BSP by typing its BSP ID into the text input area, as shown in block 208. The validation application will look up the BSP by BSP ID and display the matching BSP result.

As yet another alternative, the reviewer may search for the BSP by matching the location of the BSP with the location of the reviewer's mobile device 16, as shown in block 210. The location service of the reviewer's mobile device is required to search using location.

The reviewer may instead scan the BSP card, receipt, or similar document with the camera on the reviewer's mobile device, as shown in block 212. The camera must be positioned in a way that it can clearly capture sufficient information from the receipt or other document to identify the BSP, the BSP's name, location, phone number, and/or URL, the date and/or time of the reviewer's visit, the transaction ID, or other unique transactional identifier, such as a QRC, UPC, proprietary graphic, code or barcode (e.g. Microsoft's QRC), or artwork/design assigned to the BSP. The validation application may prompt the user to enter any information that the scan failed to detect, such as when portions of the image are blurry or when the receipt has a misprint, smudge, poor contrast, or low-resolution identifier.

The reviewer may also swipe his RFID, NFC, or other short-range radio transmission capable mobile device 16 near the BSP chip to detect the BSP review ID, as shown in block 214. The validation application may display a notification prompting the reviewer to begin or continue making the review if the mobile device detects a BSP review ID signal nearby. If any of the above BSP identification processes fail to identify a BSP, the reviewer may select an alternative process for identifying the BSP and/or validating the review by manually entering sufficient information related to their visit or the transaction to validate that he or she is/was at the BSP and he or she is/are a customer or patron of that BSP.

The reviewer may then manually start a review by entering or verifying the BSP review ID, the date and time, or any other suitable information, as shown in block 216. The reviewer may be prompted for certain information such as “today” and “right now” for inputting the date and time. Alternatively, the reviewer may be prompted to start a review after the validation application identifies the correct BSP.

The validation application may then prompt the reviewer to enter details about the review, as shown in block 218. The reviewer may enter ratings such as on a five star scale, a 1-100 point scale, a 1-10 point scale, an emotion scale, or any other rating system. The reviewer may rate specific elements of the BSP such as service, value, quality, product variety, kindness, cleanliness, and other elements. These elements may vary depending on the type of BSP being reviewed, such as a restaurant vs. a utility provider vs. a car dealership vs. a movie theater. The reviewer may also add notes and comments about his experience. A minimum or maximum number of characters may be required to validate the review. For example, the reviewer may be required to enter at least 100 non-space characters for the validation application to validate the review and ensure it is helpful or useful info.

The validation application may store details and other information about the review such as the current date and time, the BSP name, the BSP location or address, the BSP phone number, the BSP URL, the BSP review ID, any unique IDs linked to the purchase or BSP such as store number, invoice number, ticket number, tracking number, receipt number, and server name or ID, date and time of purchase, the receipt total, discounts, tax rate, tax amount, the payment method used, the reviewer's location or approximate location, and any other information, including IP address, Wi-Fi address, device MAC address, router address, geo-fence, GPS location, even proximity to a BSP USB key or similar hardware, as shown in block 220.

The reviewer may also upload one or more attachments such as images, video clips, audio clips, and other media, and may set the visibility of the attachments to public or private, as shown in block 222. An image of the receipt or BSP card may automatically be saved as a private attachment when scanned. The receipt attachment may be referenced in the future, either manually or automatically, to prove the authenticity of the review and in certain instances assist the BSP or a BSP representative (e.g. manager, employee) in finding the transaction information.

The reviewer may indicate whether he or she would like to be contacted in relation to the review, as shown in block 224. If the reviewer agrees to being contacted, the reviewer may then enter and verify his or her contact information such as his or her cell phone number and email address, name, date of birth, address, city, state, postal code, language, and social media profile(s). Alternatively, the validation application may automatically retrieve the reviewer's contact information from the reviewer's mobile device in the event they have allowed the provider application to do so, or are already registered with the provider as a reviewer (consumer user).

The validation application may then validate the review by checking the BSP review ID against BSP review IDs stored on the validation application or stored on the provider's computer system, as shown in block 226. The review is provisionally valid if no other review is associated with that BSP review ID.

Note that any receipt or transaction document may be used by multiple reviewers without being invalidated. For example, multiple guests in a party attending the same dinner may each use the same check or tab. However, the same receipt may not be used multiple times by the same reviewer. Hence, a reviewer's review may be validated using the reviewer's mobile device signature. The same receipt and the same BSP review ID may also only be used a finite number of times. Once this threshold is met, all subsequent reviews connected to that receipt or BSP review ID may be marked as inauthentic. The finite limit can be adjusted system-wide and a positive or negative variation may be set to increase or decrease a BSP's threshold compared to the system-wide setting. The threshold may also be tied to a total transaction charge, total number of guests in a party, or a service classification (e.g., restaurant, bar, theater, car dealership, or utility provider). The validation application may flag reviews tied to over-used receipts or BSP review IDs as suspicious activity for administrative review.

The validation application may retrieve from the reviewer's mobile device 16 or prompt the reviewer to enter additional identifying information to further validate the review by ensuring that the reviewer is unique, as shown in block 228. For example, the validation application may obtain the mobile device type (e.g. smartphone, tablet, laptop), signature, operating system (OS), version, model, make, storage capacity, and age. The device signature may be a unique key created by the validation application with the unique device identifier (UDID), MAC address, OpenUDID, ODIN-1, or other unique ID linked to the hardware of the mobile device. The device signature may be registered with the remote servers 12 to always be linked to that device.

The validation application may invalidate the review if the reviewer is not registered with the provider, is signed in to the validation application only as a guest, does not allow the validation application access to the location service of the mobile device and/or does not provide the current time and date, as shown in block 230. Generally, the current date and time are required for validation unless the reviewer intends to validate the review via location, PIN, BSP review ID, or other unique code.

The validation application may also invalidate the review if the BSP review ID used has surpassed the threshold for usage, or is an invalid BSP review ID, as shown in block 232. In the case the BSP review ID has surpassed the usage threshold, or is invalid, the reviewer may validate their review via another method (e.g. location, receipt artwork, etc.).

The validation application may also invalidate the review if the validation application identifies conflicting, counterfeit, or otherwise invalid information, as shown in block 234. For example, computer generated or spam reviews may be blocked or marked as invalid. The review may also be invalidated if the reviewer's location is farther than a predetermined proximity threshold from the BSP location. The validation application may also invalidate the review if the date associated with the review is set in the future or is too far in the past. Other criteria for invalidating a review include when a reviewer submits multiple reviews about a single BSP within a threshold amount of time and when a reviewer does not allow location detection and tries to submit a review as a guest.

The validation application may also detect a duplicate or counterfeit review when the receipt is scanned in a location outside of a proximity threshold distance to the original submission or in multiple locations simultaneously such as when a reviewer creates counterfeit receipts (e.g. counterfeit prints, or copies of the original) for the same BSP in different locations but scanned the receipt at the exact same time, as shown in block 236. This analysis can be performed visually such as by comparing artwork, design, color, and layout elements of the receipts or by comparing the values of data scanned from the receipts or other transactional document, such as the dates, times, values, transaction IDs, or other unique or specific transactional info that is rarely duplicated.

The validation application may flag any registered or guest reviewer or account holder for administrative review if the user submits several inauthentic reviews in a row or posts a high percentage of inauthentic reviews vs. total reviews, or ratio of inauthentic reviews to authentic reviews, as shown in block 238. The validation application may heighten the requirements for validation for future reviews submitted by the flagged user, and/or adjust system-wide validation rules and requirements for all users if there is a significant number of inauthentic reviews detected system-wide.

The reviewer may then upload the review by selecting “submit” or “done”, as shown in block 240. The validation application will then upload the review to the remote servers 12 if and when the mobile device 16 is connected to the wireless network 18.

The remote servers 12 will then publish the review, as shown in block 242. If the review was validated during the validation steps, the remote servers 12 will also mark the review as “authentic”.

If the reviewer agreed to being contacted regarding the review, the validation application may notify the BSP or a BSP representative (e.g. a manager or employee of the BSP) about the review. The BSP or BSP representative may contact the reviewer using the contact methods approved by the reviewer such as via email, social media message, phone call, email, direct mail, or other channels of communication.

Other reviewers and BSP patrons may then view the review via the validation application, the provider's website, the BSP's website, or other social media outlets (the review may have been shared by the provider, other reviewers, other users, the public, BSP, or BSP representative). The reviewers may see whether a review is validated to make an informed decision on whether to use the BSPs services or products. Reviewers may comment on the review and share the review via the social media outlets, email, SMS, or other channels of communication.

Although the invention has been described with reference to the embodiments illustrated in the attached drawing figures, it is noted that equivalents may be employed and substitutions made herein without departing from the scope of the invention.

1. A system for validating a review of a business service provider, the system comprising:
a remote server including:
a processor for hosting a business service provider review website or mobile application, the processor being configured to communicate with other electronic devices over a wireless communication network; and
a memory component for storing business service provider reviews uploaded to the website or mobile application by reviewers over the wireless communication network; and
a plurality of business service provider hardware devices each configured to present business service provider review identifiers to reviewers when the reviewers patronize a business service provider, each business service provider review identifier being a unique code corresponding to a single review or set of reviews related to a reviewer or a set of reviewers' experience or experiences in patronizing the business service provider, each business service provider review identifier including a business service provider identifier corresponding to one of the business service providers.

2. The system of claim 1, further comprising:
a review validation application including a graphical user interface configured to be displayed on a mobile device of the reviewer, the review validation application including code segments for:
receiving one of the business service provider review identifiers;
prompting the reviewer to enter a review into a text input area of the graphical user interface;
validating the review by linking the business service provider review identifier to the review;
marking the review as “valid” or “authentic” if the validation is successful; and
uploading the review marked as “valid” or “authentic” to the website via the wireless communication network.

3. The system of claim 2, wherein the review validation application further includes a code segment for prompting the reviewer to enter, set, or confirm a rating into the graphical user interface.

4. The system of claim 2, wherein the review validation application further includes code segments for determining a location of the business service provider and determining a location of the reviewer's mobile device when the reviewer enters the review, the review being further validated by determining if the location of the mobile device is within a predetermined distance from the business service provider when the review is created.

5. The system of claim 2, wherein the review is further validated by checking previously uploaded reviews stored on the remote servers so as to verify that the previously uploaded reviews are not linked to the business service provider review identifier.

6. The system of claim 2, wherein the remote server is configured to store accounts associated with reviewers, the review validation application further including a code segment for flagging an account of a reviewer for administrative review if the account is associated with inauthentic reviews.

7. The system of claim 2, wherein the processors of the remote servers are configured to manage transactional documents uploaded by business service providers for use in transactions incorporating business service provider reviews.

8. The system of claim 7, wherein the processors of the remote servers are configured to link the transactional documents with a number of related business service providers.

9. The system of claim 2, wherein the review validation application is integrated into the business service provider hardware devices.

10. The system of claim 1, further comprising a plurality of USB devices configured to be connected to the business service provider hardware devices, the USB devices being configured to emit a unique business service provider review identifier.

11. The system of claim 1, further comprising a plurality of programmable chips configured to be integrated into the business service provider hardware devices and a plurality of USB devices configured to program the programmable chips to emit a unique business service provider review identifier.

12. A method of validating a review of a business service provider, the method comprising the steps of:
hosting a business service provider review website on a remote server, the website being accessible over a wireless communication network;
presenting a business service provider review identifier to a reviewer when the reviewer patronizes a business service provider, the business service provider review identifier being a unique code corresponding to a single review or set of reviews related to the reviewer or a set of reviewers' experience or experiences in patronizing the business service provider, the business service provider review identifier including a business service provider identifier corresponding to one of the business service providers;
prompting the reviewer to enter a review into a text input area of a graphical user interface of a mobile device of the reviewer;
validating the review by:
linking the business service provider review identifier to the review; and
checking previously uploaded reviews stored on the remote server to verify that the previously uploaded reviews are not linked to the business service provider review identifier; and
storing the validated business service provider review on the remote server such that potential patrons of the business service provider can view the review via mobile devices over a the wireless communication network.

13. The method of claim 12, further comprising the step of detecting the business service provider review identifier when the reviewer scans a business service provider card via a camera of mobile device.

14. The method of claim 12, further comprising the step of detecting the business service provider review identifier when the reviewer swipes a mobile device near a business service provider chip.

15. The method of claim 12, further comprising the steps of determining a location of the business service provider and determining a location of a mobile device of the reviewer when the reviewer enters the review, the step of validating the review further comprising the step of determining if the location of the mobile device of the reviewer is within a predetermined distance from the business service provider when the review is created.

16. The method of claim 12, further comprising the step of prompting the reviewer to enter, set, or confirm a rating into the graphical user interface of the mobile device of the reviewer.

17. The method of claim 12, further comprising the step of flagging an account of the reviewer for administrative review if the reviewer submits several inauthentic reviews in a row or posts a high percentage of inauthentic reviews vs. total reviews, or ratio of inauthentic reviews to authentic reviews.

18. The method of claim 17, further comprising heightening the requirements for validation for future reviews submitted by the reviewer associated with the flagged account.

19. The method of claim 12, further comprising the step of marking the review as “valid” or “authentic” if the validation is successful.

20. A system for validating a review of a business service provider, the system comprising:
a remote server including:
a processor for hosting a business service provider review website or mobile application, the processor being configured to communicate with other electronic devices over a wireless communication network; and
a memory component for storing business service provider reviews uploaded to the website or mobile application by reviewers over the wireless communication network;
a plurality of business service provider hardware devices each configured to present business service provider review identifiers to reviewers when the reviewers patronize a business service provider, each business service provider review identifier being a unique code corresponding to a single review or set of reviews related to a reviewer or a set of reviewers' experience or experiences in patronizing the business service provider, each business service provider review identifier including a business service provider identifier corresponding to one of the business service providers; and
a plurality of mobile devices each including a memory element, a processor for running a review validation application, and a display for displaying a graphical user interface, the review validation application including code segments for:
receiving one of the business service provider review identifiers;
prompting the reviewer to enter, set, or confirm a rating into the graphical user interface;
prompting the reviewer to enter a review into a text input area of the graphical user interface;
determining a location of the mobile device when the reviewer enters the review;
determining a location of the business service provider;
validating the review by:
linking the business service provider review identifier to the review;
checking previously uploaded reviews stored on the servers to verify that the previously uploaded reviews are not linked to the business service provider review identifier; and
determining if the location of the mobile device is within a predetermined distance from the business service provider when the review is created;
marking the review as “valid” or “authentic” if the validation is successful; and
uploading the review to the website via the wireless communication network.
